(19) United States
(12) Patent Application Publication
(10) Pub. No.: US 2010/0225310 A1
(43) Pub. Date: Sep. 9, 2010

(54) TOUCH-DOWN DETERMINING DEVICE, TOUCH-DOWN DETERMINING METHOD, AND MAGNETIC DISK DEVICE

(75) Inventor: Masatoshi SUDOU, Kawasaki-Shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/717,802

(22) Filed: Mar. 4, 2010

(30) Foreign Application Priority Data
Mar. 5, 2009 (JP) 2009-052535

(51) Int. Cl. G01N 27/72

(52) U.S. Cl. 324/213

(57) ABSTRACT

According to one embodiment, a touch-down determining device, includes: an alternating current perturbation module configured to periodically perturb power of a heater by an alternating current, the heater adjusting protrusion amounts of a write magnetic pole and a read element of a magnetic head in a direction towards a recording medium; a change detector configured to detect a change in a spectrum level of a portion of a spectrum of a read signal read from the recording medium by the magnetic head receiving the power perturbed by the alternating current, the portion of the spectrum corresponding to the alternating current; and a touch-down determining module configured to determine whether touch-down is made, based on the change in the spectrum level detected by the change detector.

### CROSS-REFERENCE TO RELATED APPLICATIONS

This application is based upon and claims the benefit of priority from Japanese Patent Application No. 2009-052535, filed Mar. 5, 2009, the entire contents of which are incorporated herein by reference.

### BACKGROUND

1. Field

One embodiment of the invention relates to a touch-down determining device, a touch-down determining method, and a magnetic disk device.

2. Description of the Related Art

In recent years, in a hard disk device or in a device for evaluating a magnetic head or a medium provided in a hard disk device, the floating height of the magnetic head is adjusted to maintain an appropriate clearance between the magnetic head and the medium. In this case, power of a heater, that is, touch-down heater power (TDP) of when the magnetic head contacts the medium is measured by increasing the power of the heater used to adjust the floating height of the magnetic head from the medium. Accordingly, the floating height of the magnetic head is measured using the measured TDP. Since the TDP is used to set the floating height of the magnetic head, the TDP affects performance of the hard disk device. Therefore, various attempts to improve detection precision of the TDP have been made (for example, see Japanese Patent Application Publication (KOKAI) No. 2004-13931).

For example, there has been suggested a method (hereinafter, referred to as method 1) that determines a timing at when a level of a read signal at the time of increasing the heater power becomes a defined level or less with respect to a signal level of immediately previous heater power. Further, there has been suggested a method (hereinafter, referred to as method 2) that determines a timing at when an actual level of a read signal becomes the defined level or less with respect to a level of a read signal predicted at the heater power at a current point of time from a relationship between heater power before the heater power at the current point of time and a level change of the read signal. Still further, there has been suggested a method (hereinafter, referred to as method 3) that divides a signal recorded on a medium into a plurality of blocks of one cycle of the medium, reads the divided signal, and determines a timing when a change in characteristic value between the blocks becomes a defined value or more. Still further, there has been suggested a method (referred to as method 4) that determines touch-down by a change of spectrums due to a characteristic vibration of each part of a suspension of a head, using a spectrum analyzer.

However, the suggested methods in the conventional technology that are obtained by the various attempts to improve the detection precision of the TDP are not preferable. For example, in the method 1 or 2, if reproducibility of measurements of the characteristic value is low, the touch-down of the head may erroneously be determined, even when the head is not in contact with the medium. On the other hand, in the method 1 or 2, a determination level may be lowered to prevent the erroneous determination. However, for this reason, the touch-down may not be determined even though the magnetic head contacts the medium. Accordingly, the heater power is further increased, but this may result in damaging the medium or the magnetic head. In the method 3, it becomes necessary to provide a circuit that divides one cycle of the record signal and reads the signal, and a system that processes the operation at a high speed. In the method 4, when the touch-down is detected using a change in spectrums before and after the touch-down, it may be easy for some heads to detect the touch-down, but it may be difficult for some other heads to detect the touch-down. Furthermore, in the method 4, since the spectrum power of the characteristic vibration is weak, it may be difficult to detect the spectrum corresponding to the characteristic vibration and difficult to determine the touch-down.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary functional block diagram of configurations according to a first embodiment of the invention;

FIG. 2 is an exemplary graph of heater power at the time of detecting touch-down;

FIG. 3 is an exemplary explanatory diagram for explaining heater power at the time of detecting the touch-down in the first embodiment;

FIG. 4 is an exemplary diagram of a spectrum of a read signal corresponding to a direct current on which an alternating-current is not superimposed in the first embodiment;

FIG. 5 is an exemplary diagram of a spectrum of a read signal corresponding to a direct current on which an alternating-current is superimposed in the first embodiment;

FIG. 6 is another exemplary diagram of the spectrum of the read signal corresponding to the direct current on which the alternating-current is superimposed in the first embodiment;

FIG. 7 is still another exemplary diagram of the spectrum of the read signal corresponding to the direct current on which the alternating-current is superimposed in the first embodiment;

FIG. 8 is still another exemplary diagram of the spectrum of the read signal corresponding to the direct current on which the alternating-current is superimposed in the first embodiment;

FIG. 9 is still another exemplary diagram of the spectrum of the read signal corresponding to the direct current on which the alternating-current is superimposed in the first embodiment;

FIG. 10 is an exemplary flowchart of touch-down detecting process in the first embodiment; and

FIG. 11 is an exemplary flowchart of detection condition optimizing process in the first embodiment.

### DETAILED DESCRIPTION

Various embodiments according to the invention will be described hereinafter with reference to the accompanying drawings. In general, according to one embodiment of the invention, a touch-down determining device, comprises: an alternating current perturbation module configured to periodically perturb power of a heater by an alternating current, the heater adjusting protrusion amounts of a write magnetic pole and a read element of a magnetic head in a direction towards a recording medium; a change detector configured to detect a change in a spectrum level of a portion of a spectrum of a read signal read from the recording medium by the magnetic head receiving the power perturbed by the alternating current, the portion of the spectrum corresponding to the alternating current; and a touch-down determining module configured to determine whether touch-down is made, based on the change in the spectrum level detected by the change detector.

According to another embodiment of the invention, a touch-down determining method, comprises: periodically perturbing power of a heater by an alternating current, the heater adjusting protrusion amounts of a write magnetic pole and a read element of a magnetic head in a direction towards a recording medium; detecting a change in a spectrum level of a portion of a spectrum of a read signal read from the recording medium by the magnetic head receiving the power perturbed by the alternating current, the portion of the spectrum corresponding to the alternating current; and determining whether touch-down is made, based on the change in the spectrum level detected by the detecting.

According to still another embodiment of the invention, a magnetic disk device, comprises: an alternating current perturbation module configured to periodically perturb power of a heater by an alternating current, the heater adjusting protrusion amounts of a write magnetic pole and a read element of a magnetic head in a direction towards a recording medium; a change detector configured to detect a change in a spectrum level of a portion of a spectrum of a read signal read from the recording medium by the magnetic head receiving the power perturbed by the alternating current, the portion of the spectrum corresponding to the alternating current; and a touch-down determining module configured to determine whether touch-down is made, based on the change in the spectrum level detected by the change detector.

A touch-down determining device according to a first embodiment detects power of a heater of when a magnetic head contacts a medium in a magnetic disk device, that is, touch-down heater power (TDP).

Specifically, the touch-down determining device according to the first embodiment periodically perturbs power of the heater according to an alternating current. The heater adjusts the protrusion amounts of a write magnetic pole and a read element of the magnetic head in a direction towards a recording medium. By the magnetic head that receives the heater power perturbed according to the alternating current, a change in a spectrum level is detected for a portion of a spectrum of the read signal read from the recording medium. Here, the portion of the spectrum corresponds to the alternating current. Then, it is determined whether touch-down is made based on the detected change in the spectrum level.

For example, when the level of the spectrum corresponding to the alternating current is decreased, it is determined that the touch-down is made. That is, when the magnetic head and the recording medium are not in contact, a peak corresponding to a frequency of the alternating current exists in the spectrum of the read signal read from the recording medium by the magnetic head that receives the heater power perturbed according to the alternating current. On the other hand, when the magnetic head and the recording medium are in contact with each other so that the floating height of the magnetic head is increased or irregularly changed, a level of the read signal is affected by the change in the floating height and greatly changes. For this reason, the peak corresponding to the frequency of the alternating current decreases or disappears. In view of this characteristic, the touch-down determining device according to the first embodiment performs the touch-down determination.

Consequently, the touch-down determining device according to the first embodiment can detect the touch-down (TDP) with high precision. Hereinafter, an embodiment of the touch-down determining device according to the first embodiment will be specifically described.

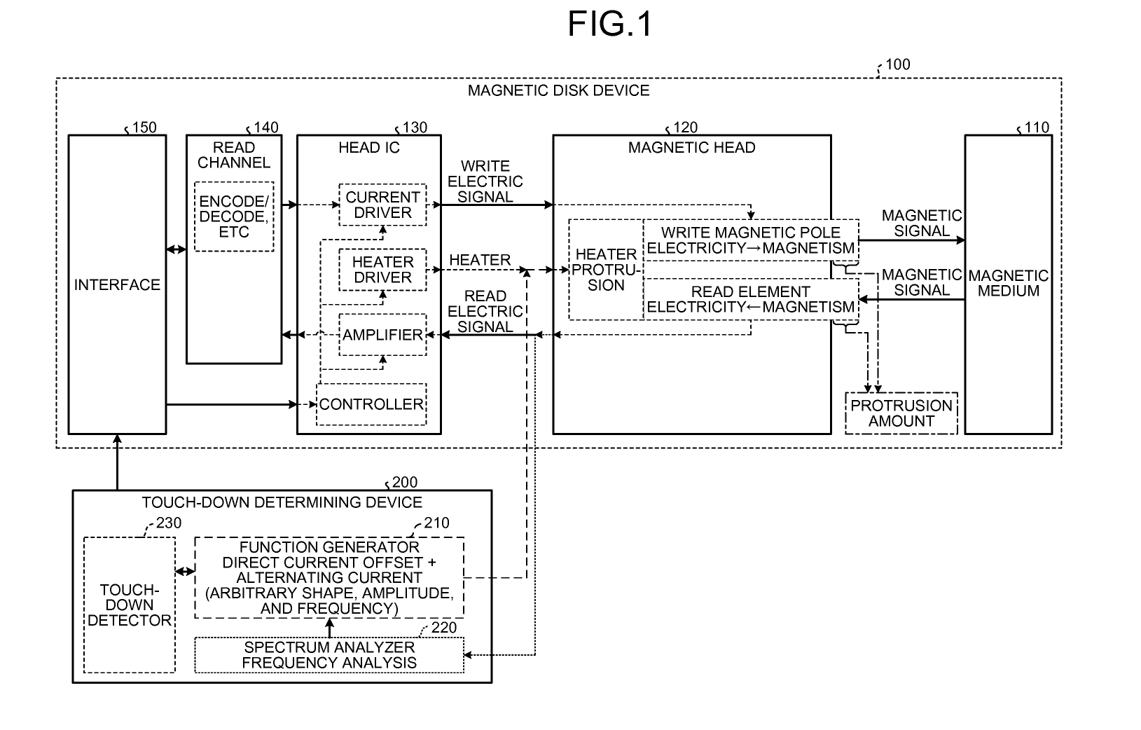

FIG. 1 is a functional block diagram of a configuration according to the first embodiment. As illustrated in FIG. 1, a magnetic disk device 100 that is determined by the touch-down determining device according to the first embodiment comprises a magnetic medium 110, a magnetic head 120, a head IC 130, a read channel 140, and an interface 150.

The magnetic medium 110 is made by laminating a soft magnetic layer (soft under layer (SUL)) and a recording layer on a glass substrate. In the magnetic medium 110, a data signal is recorded by the magnetic head 120. The magnetic head 120 has a write magnetic pole, a read element, and a heater, and is mounted on a slider using AlTiC as a substrate material. If the power of the heater is increased by the head IC 130, the protrusion amounts of the write magnetic pole and the read element increase, and the write magnetic pole and the read element further approach the magnetic medium 110.

As illustrated in FIG. 1, the head IC 130 has a current driver, a heater driver, an amplifier, and a controller. The head IC 130 increases the heater power of the magnetic head 120, changes the protrusion amounts of the write magnetic pole and the read element, and adjusts the strengths of a record signal with respect to the magnetic medium 110 and a reproduction signal from the magnetic medium 110. The read channel 140 encodes the recording signal and decodes the reproduction signal. The interface 150 controls an information exchange with a host computer (not illustrated in FIG. 1) or a touch-down determining device 200.

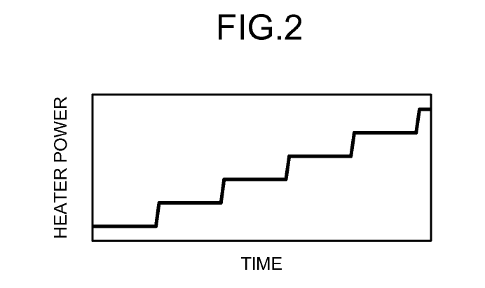

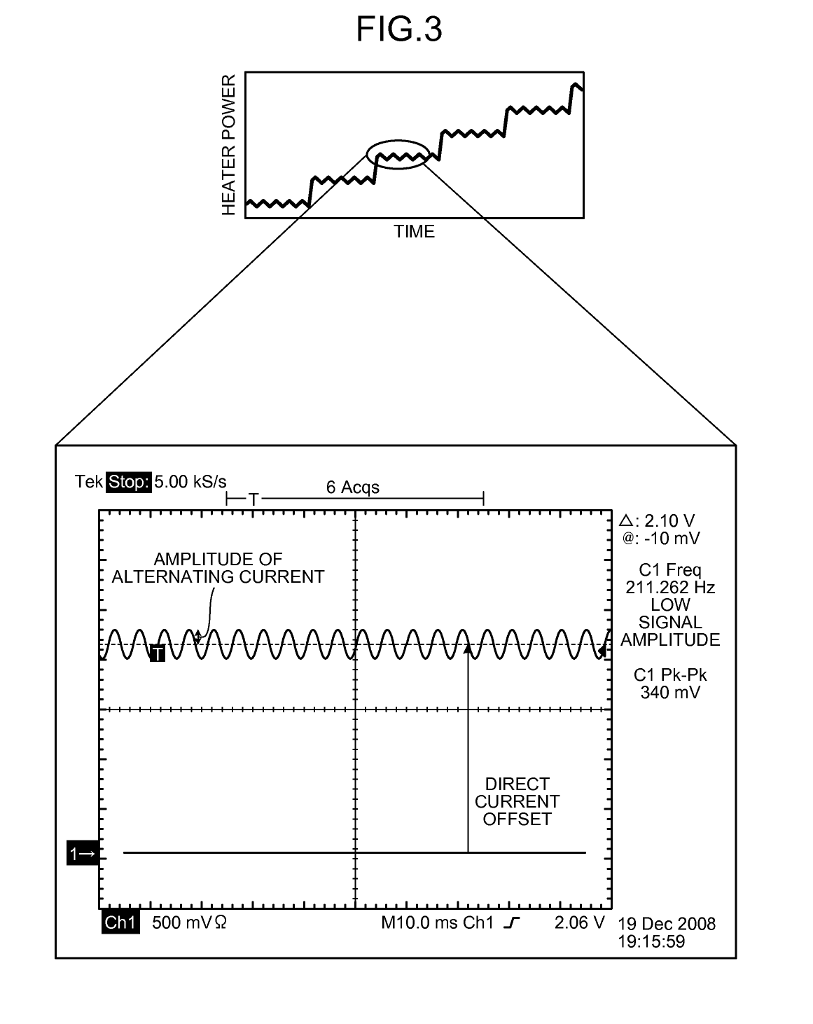

As illustrated in FIG. 1, the touch-down determining device 200 comprises a function generator 210, a spectrum analyzer 220, and a touch-down detector 230. When the touch-down determining device 200 introduces the heater power (refer to FIG. 2) that stepwisely increases until the heater power (TDP) at the time of the touch-down is detected, the touch-down determining device 200 perturbs the heater power according to an alternating current (refer to FIG. 3). The touch-down determining device 200 detects the touch-down (TDP) from the change in the spectrum level of the read signal corresponding to the alternating current. FIG. 2 illustrates conventional heater power at the time of detecting touch-down. FIG. 3 illustrates heater power at the time of detecting touch-down in the first embodiment. Hereinafter, the individual function modules that are comprised in the touch-down determining device 200 will be specifically described.

The function generator 210 supplies direct current power to the heater, and controls ON/OFF of the heater of the magnetic head 120 or the level of the heater power. When the function generator 210 supplies the direct current power to the heater, the function generator 210 superimposes the alternating-current on the direct current to periodically perturb the heater power in accordance with the alternating current. The alternating-current has a frequency of a waveform of the alternating-current, a shape of the waveform, and amplitude (change) of the waveform.

When the function generator 210 receives a touch-down determination start instruction from the touch-down detector 230, the function generator 210 sets an initial value to turn on the heater power. Then, the function generator 210 executes process of optimizing a condition to detect the touch-down (TDP), and superimposes the alternating-current on the direct current when the heater power is turned on by the direct current.

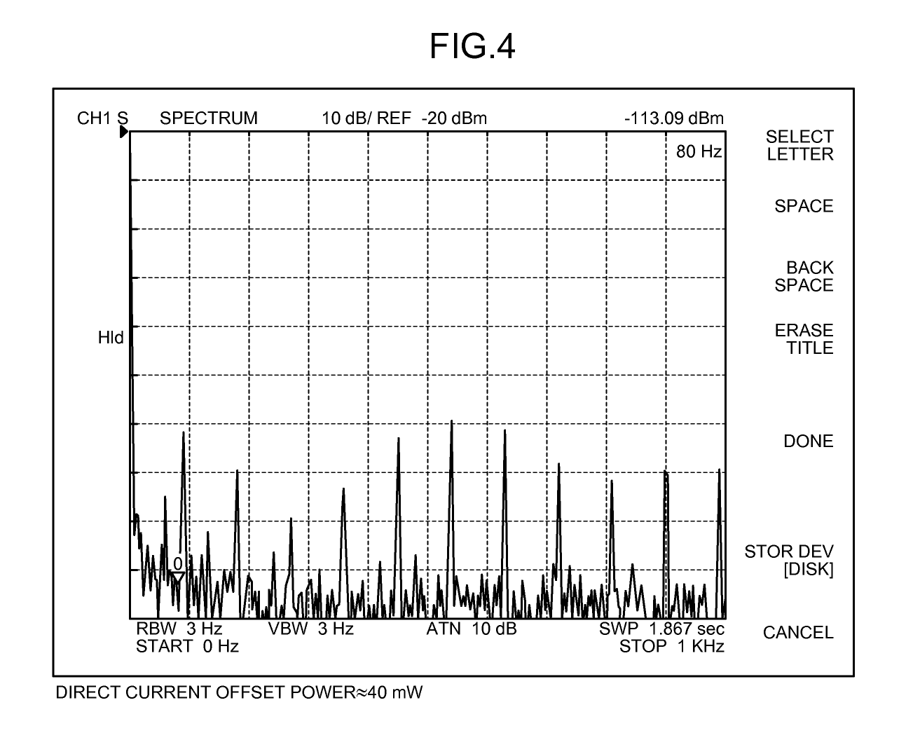

Specifically, the function generator 210 turns on the heater power by the direct current of a value set as the initial value, and acquires a spectrum analysis result of a read signal corresponding to the heater power not perturbed by the alternating current (the heater power corresponding only to the direct current), from the spectrum analyzer 220. For example, a spectrum analysis result of a read signal of when the heater power is turned on by direct current (offset) power of about 40 mW is illustrated in FIG. 4. FIG. 4 illustrates an example of a spectrum of a read signal corresponding to the direct current on which the alternating-current is not superimposed in the first embodiment.

After the spectrum analysis result is acquired, the function generator 210 selects a frequency that is not affected by the surroundings (neighboring spectrum peak is apart by several hertz or more) as a frequency of an alternating-current, from the spectrum analysis result.

After the frequency is selected, the function generator 210 sets a shape of the waveform of the alternating-current as a sine wave, a triangular wave, a rectangular wave, etc. The function generator 210 sets the amplitude (change) to plus/minus several milliwatt with respect to the direct current power supplied to the heater. After the shape and the amplitude are set, the function generator 210 superimposes on the direct current the alternating-current of the waveform having the selected frequency, the set shape, and the amplitude, when the heater power is turned on by the direct current power. The function generator 210 acquires the spectrum analysis result of the read signal corresponding to the heater power perturbed according to the alternating current, from the spectrum analyzer 220.

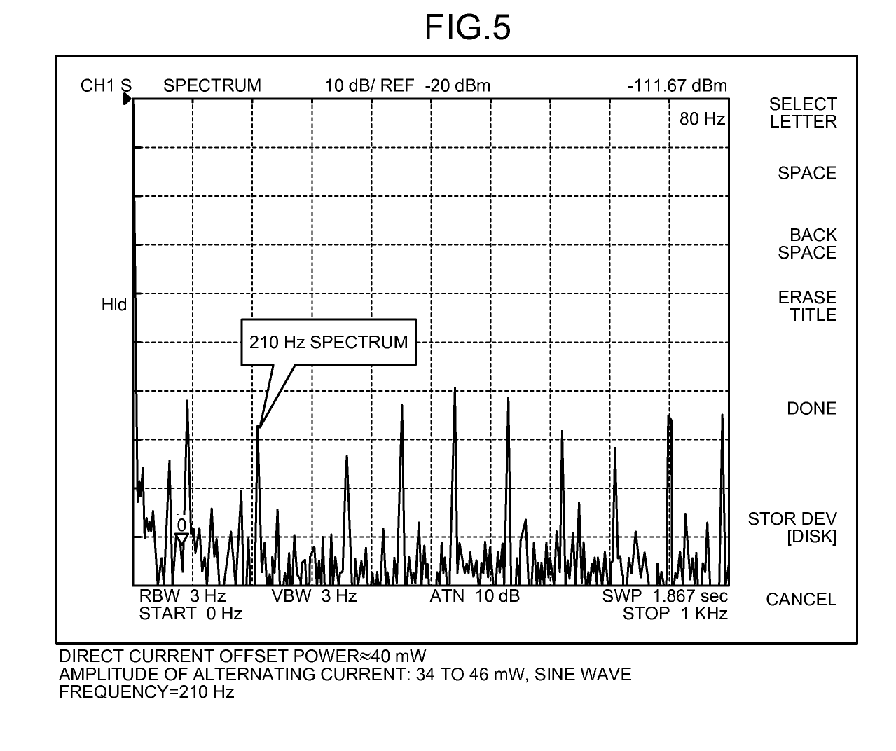

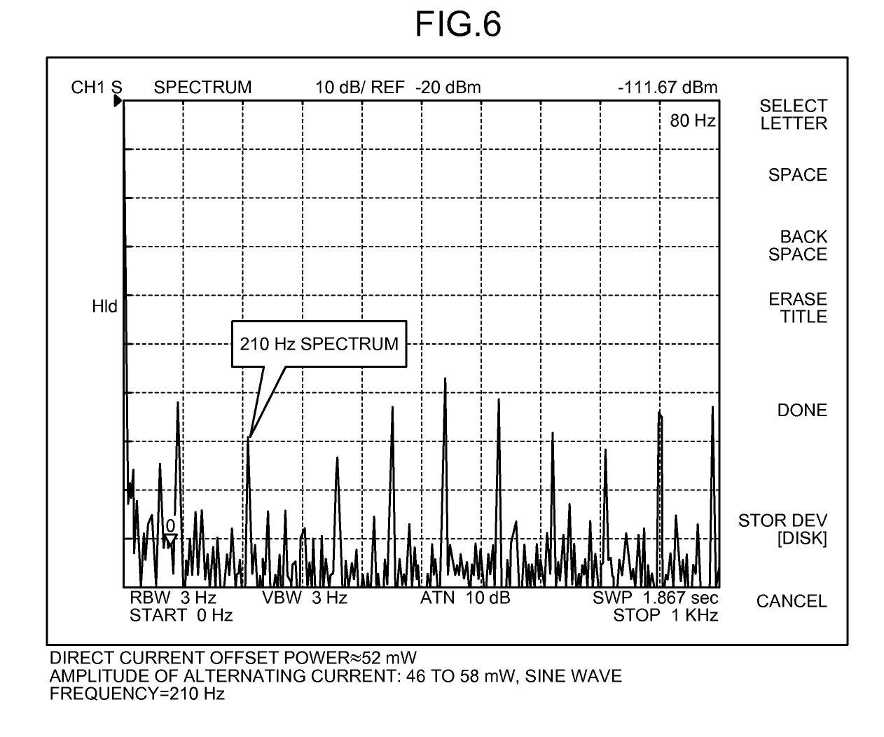

FIG. 5 illustrates a spectrum analysis result of a read signal of when the heater power is turned on by the direct current (offset) power of about 40 mW, on which alternating-current having a waveform (having a frequency of 210 Hz, amplitude (amount of perturbation by the alternating-current) of 34 to 46 mW, and a shape of a sine wave) are superimposed. FIG. 6 illustrates a spectrum analysis result of a read signal of when the heater power is turned on by the direct current (offset) power of about 52 mW, on which alternating-current having a waveform (having a frequency of 210 Hz, amplitude (amount of perturbation by the alternating current) of 46 to 58 mW, and a shape of a sine wave) are superimposed. FIGS. 5 and 6 illustrate an example of a spectrum of a read signal corresponding to the direct current on which the alternating-current is superimposed in the first embodiment.

Next, the function generator 210 determines whether a spectrum analysis result of a read signal of when the heater power is perturbed according to the alternating current clearly differs from a spectrum analysis result of a read signal of when the heater power that is not perturbed according to the alternating current. Specifically, the function generator 210 determines whether a difference obtained by subtracting the spectrum analysis result of the read signal of when the heater power is not perturbed according to the alternating current from the spectrum analysis result of the read signal of when the heater power is perturbed according to the alternating current exceeds a predetermined threshold value.

As the result of determination, when the difference of the spectrum analysis result exceeds the predetermined threshold value, the function generator 210 determines whether the spectrum analysis result of the read signal of when the heater power is perturbed according to the alternating current clearly differs from the spectrum analysis result of the read signal of when the heater power is not perturbed according to the alternating current. Then, the function generator 210 determines the frequency, the shape, and the amplitude of the waveform of the current alternating-current as a frequency, a shape, and amplitude at the time of detecting the touch-down.

After the alternating-current is determined, the function generator 210 introduces the heater power that is not perturbed according to the alternating current into the heater, proceeds to the touch-down detecting process, and delivers the spectrum analysis result, which is acquired from the spectrum analyzer 220, to the touch-down detector 230.

Meanwhile, as the result of determination, when the difference of the spectrum analysis results does not exceed the predetermined threshold value, the function generator 210 changes the shape and the amplitude of the waveform of the alternating-current, and turns on the heater power based on the direct current power on which this alternating-current is superimposed.

Then, as similar to the above case, the function generator 210 superimposes the alternating-current with the changed shape and the amplitude, when the heater power is turned on by the direct current power. The function generator 210 acquires the spectrum analysis result of the read signal of when the heater power is perturbed according to the alternating current from the spectrum analyzer 220. The function generator 210 determines whether the spectrum analysis result of the read signal of when the heater power is perturbed according to the alternating current clearly differs from the spectrum analysis result of the read signal of when the heater power is not perturbed according to the alternating current (heater power corresponding only to the direct current power). The function generator 210 repeats the processes similar to that of the above processes until it is determined that the difference between the spectrum analysis results becomes clear.

The spectrum analyzer 220 analyzes a frequency of the read signal that is read by the magnetic head 120, and delivers the spectrum analysis result obtained as the frequency analysis result to the function generator 210.

The touch-down detector 230 outputs a touch-down determination start instruction to the function generator 210. The touch-down detector 230 detects the change in the level of the spectrum of the direct current on which the alternating current is superimposed, from the spectrum analysis result of the read signal corresponding to the heater power that is perturbed according to the alternating current, and determines whether the touch-down is made.

Specifically, the touch-down detector 230 determines whether the spectrum level corresponding to the direct current on which the alternating current is superimposed decreases. As the result of determination, when the spectrum level corresponding to the alternating current decreases, the touch-down detector 230 determines that the touch-down is made. For example, when the difference obtained by subtracting the spectrum analysis result of the read signal corresponding to the heater power that is not perturbed according to the alternating current (heater power corresponding only to the direct current power) from the spectrum analysis result of the read signal corresponding to the heater power that is perturbed according to the alternating current is less than the predetermined threshold value, the function generator 210 determines that the spectrum level corresponding to the alternating current is decreased, and determines that the touch-down is made.

The function generator 210 determines whether a value obtained by dividing the spectrum analysis result of the read signal corresponding to the heater power that is perturbed according to the alternating current by the spectrum analysis result of the read signal corresponding to the heater power that is not perturbed according to the alternating current is less than the predetermined threshold value. When it is determined that the value is less than the predetermined threshold value, the function generator 210 determines that the spectrum level corresponding to the alternating current is decreased, and can determine that the touch-down is made.

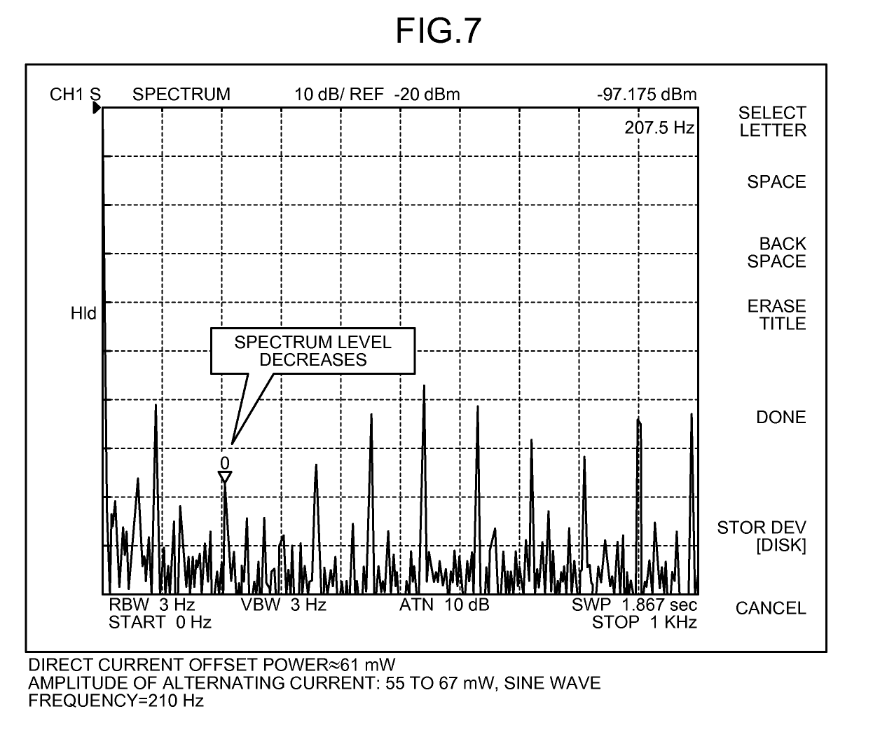

FIG. 7 illustrates a spectrum analysis result of a read signal of when the heater power is turned on by the direct current (offset) power of about 61 mW, on which alternating-current having a waveform (having a frequency of 210 Hz, amplitude (amount of perturbation by the alternating current) of 55 to 67 mW, and a shape of a sine wave) is superimposed. As compared with the spectrum analysis result illustrated in FIG. 6, the spectrum level corresponding to the alternating-current is reduced. FIG. 7 illustrates an example of a spectrum of a read signal corresponding to the direct current on which the alternating-current is superimposed in the first embodiment.

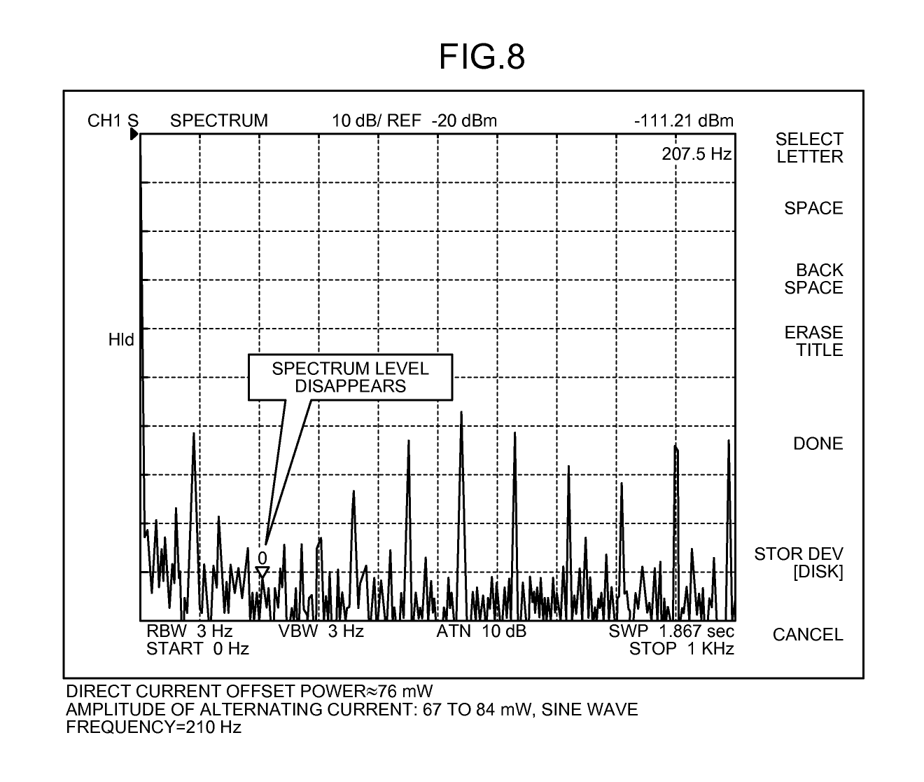

FIG. 8 illustrates a spectrum analysis result of a read signal of when the heater power turned on by the direct current (offset) power of about 76 mW, on which alternating-current having a waveform (having amplitude (corresponding to the amount of perturbation by the alternating current) of 67 to 84 mW and a shape of a sine wave) is superimposed. FIG. 8 illustrates the case when the spectrum level corresponding to the alternating-current completely disappears.

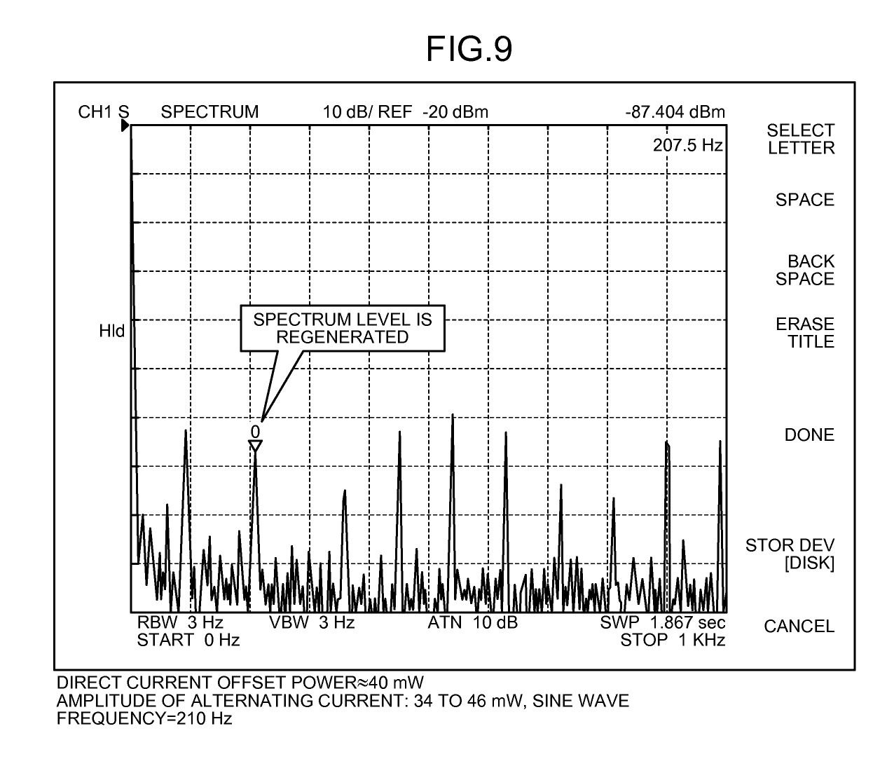

FIG. 9 illustrates a spectrum analysis result of a read signal of when the heater power is turned on by the direct current (offset) power of about 40 mW, on which alternating-current having a waveform (having a frequency of 210 Hz, amplitude (corresponding to the amount of perturbation by the alternating current) of 34 to 46 mW, and a shape of a sine wave) is superimposed. Even though the spectrum level corresponding to the alternating-current completely disappears as illustrated in FIG. 8, the spectrum level corresponding to the alternating-current is regenerated as illustrated in FIG. 9 by decreasing the heater power from 76 mW to 40 mW. FIGS. 8 and 9 illustrate an example of a spectrum of a read signal corresponding to the direct current on which an alternating-current is superimposed in the first embodiment.

As the result of determination, when the difference of the spectrum analysis results is less than the predetermined threshold value, the touch-down detector 230 determines that the touch-down is made, and outputs the current direct current power value as the TDP to the magnetic disk device 100.

Meanwhile, as the result of determination on whether the spectrum level corresponding to the alternating current is decreased, when the spectrum level corresponding to the alternating current is not decreased (when the difference between the spectrum analysis results is not less than the predetermined threshold value), the touch-down detector 230 determines that the touch-down is not made. Accordingly, the touch-down detector 230 changes the current direct current power value and instructs the function generator 210 to increase the heater power.

Then, as similar to the above case, the spectrum analysis result of the read signal corresponding to the heater power that is not perturbed by the alternating current and the spectrum analysis result of the read signal corresponding to the heater power that is perturbed by the alternating current are acquired, and the determination of the touch-down is performed. The touch-down detector 230 repeats the processes same as that of the above processes, until the determination of the touch-down is performed.

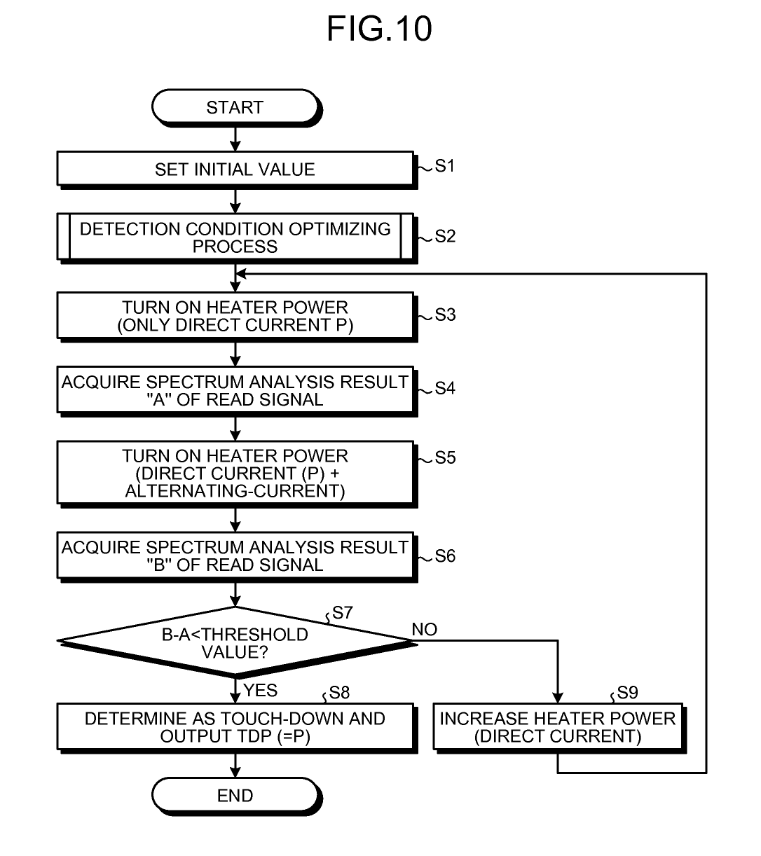

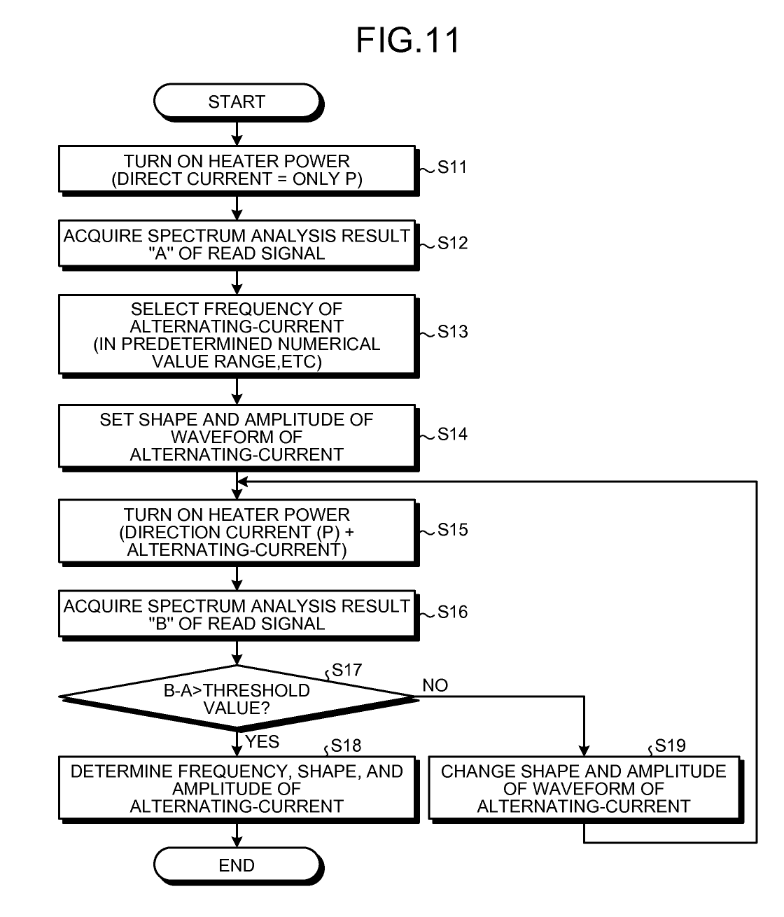

FIG. 10 illustrates a flowchart of the touch-down detecting process in the first embodiment. As illustrated in FIG. 10, when the function generator 210 receives a touch-down determination start instruction from the touch-down detector 230, the function generator 210 sets an initial value so as to turn on the heater power (S1). As will be described in detail below with reference to FIG. 11, the function generator 210 executes process of optimizing a condition to detect the touch-down (TDP) (S2), and determines the alternating-current that is superimposed on the direct current.

After the detection condition optimizing process is completed, the function generator 210 turns on the heater power by the direct current power of a value (for example, P) set as the initial value (S3). Then, at the time of transmitting the direct current heater power, the function generator 210 acquires from the spectrum analyzer 220 a spectrum analysis result (for example, A) of a read signal corresponding to the heater power by the direct current on which the alternating-current is not superimposed (S4).

Next, when the heater power is turned on by the direct current power, the function generator 210 superimposes on the direct current the alternating-current with the waveform having the frequency, the set shape, and amplitude obtained during the detection condition optimizing process (S5). The function generator 210 acquires a spectrum analysis result (for example, B) of the read signal corresponding to the heater power that is perturbed by the alternating current, from the spectrum analyzer 220 (S6), and delivers the individual spectrum analysis results (for example, A and B) to the touch-down detector 230.

When the touch-down detector 230 receives the individual spectrum analysis results (for example, A and B), the touch-down detector 230 detects the change in the spectrum level corresponding to the alternating current, and determines whether the touch-down is made. Specifically, the touch-down detector 230 determines whether the spectrum level corresponding to the alternating current is decreased (S7).

As the result of determination, when the spectrum level corresponding to the alternating current is decreased (Yes at S7), the touch-down detector 230 determines that the touch-down is made, and outputs the current direct current power (for example, P) as the TDP to the magnetic disk device 100 (S8). As a method that determines whether the spectrum level corresponding to the alternating current is decreased, the following method is used. For example, when the difference obtained by subtracting the spectrum analysis results (for example, A and B) of the read signal corresponding to the heater power that is not perturbed according to the alternating current (heater power corresponding only to the direct current power) from the spectrum analysis result (for example, B) of the read signal corresponding to the heater power that is perturbed according to the alternating current is less than the predetermined threshold value, the touch-down detector 230 determines that the spectrum level is decreased.

Meanwhile, as the result of determination, when the spectrum level corresponding to the alternating current is not decreased (when the difference between the spectrum analysis results is not less than the predetermined threshold value) (No at S7), the touch-down detector 230 determines that the touch-down is not made. Accordingly, the touch-down detector 230 changes the current direct current power value, and instructs the function generator 210 to increase the heater power (S9).

Hereinafter, the touch-down detector 230 repeats the processes of S3 to S7, until the determination of the touch-down is performed.

FIG. 11 illustrates a flowchart of detection condition optimizing process in the first embodiment. As illustrated in FIG. 11, the function generator 210 turns on the heater power by the direct current power of the value set as the initial value (S11). Then, at the time when the direct current power is transmitted, the function generator 210 acquires the spectrum analysis result (for example, A) of the read signal corresponding to the heater power on which the alternating current power is not superimposed so that the heater power is not perturbed by the alternating current, from the spectrum analyzer 220 (S12).

After the spectrum analysis result (for example, A) is acquired, the function generator 210 selects a frequency that is not affected by other spectrum (frequency with neighboring spectrum peak being apart by several hertz or more) as a frequency of an alternating-current, from the spectrum analysis result (S13). After the frequency is selected, the function generator 210 sets a shape of the waveform of the alternating-current as a sine wave, a triangular wave, a rectangular wave, etc. The function generator 210 sets amplitude (change) of plus/minus several milliwatt with respect to the direct current power supplied to the heater (S14).

After the shape and the amplitude are set, the function generator 210 superimposes on the direct current the alternating-current of the waveform having the selected frequency, the set shape, and amplitude, thereby turns the heater power by this direct current power (S15). The function generator 210 acquires the spectrum analysis result of the read signal corresponding to the heater power that is perturbed according to the alternating current, from the spectrum analyzer 220 (S16).

Next, the function generator 210 determines whether the spectrum analysis result (for example, B) of the read signal corresponding to the heater power that is perturbed by the alternating current clearly differs from the spectrum analysis result (for example, A) of the read signal corresponding to the heater power that is not perturbed by the alternating current. Specifically, the function generator 210 determines whether the difference obtained by subtracting the spectrum analysis result (for example, A) of the read signal corresponding to the heater power that is not perturbed by the alternating current from the spectrum analysis result (for example, B) of the read signal corresponding to the heater power that is perturbed by the alternating current exceeds the predetermined threshold value (S17).

As the result of determination, when the difference of the spectrum analysis results (difference obtained by subtracting A from B) exceeds the predetermined threshold value (Yes at S17), the function generator 210 determines that the spectrum analysis result (for example, B) of the read signal corresponding to the heater power that is perturbed by the alternating current clearly differs from the spectrum analysis result (for example, A) of the read signal corresponding to the heater power that is not perturbed by the alternating current. Then, the function generator 210 determines the frequency, the shape, and the amplitude of the waveform of the current alternating-current as a frequency, a shape, and amplitude of the alternating current of when the touch-down detecting process (refer to FIG. 10) is executed (S18).

After the alternating-current is determined, as illustrated in S13 of FIG. 10 described above, the function generator 210 turns on the heater power by the direct current power and proceeds to the touch-down detecting process. Then, the function generator 210 delivers the spectrum analysis result, which is acquired from the spectrum analyzer 220, to the touch-down detector 230.

Referring back to the description of S17, as the result of determination, when the difference of the spectrum analysis results (difference obtained by subtracting A from B) does not exceed the predetermined threshold value (No at S7), the function generator 210 changes the shape and the amplitude of the waveform of the alternating-current (S19). Then, the function generator 210 returns to S5 and turns on the heater power by the changed alternating current.

Then, as similar to S16 described above, the function generator 210 acquires the spectrum analysis result of the read signal corresponding to the heater power that is perturbed by the alternating-current with the changed shape and the amplitude, from the spectrum analyzer 220. Then, as similar to S17 described above, the function generator 210 determines whether the spectrum analysis result of the read signal corresponding to the heater power that is perturbed by the alternating current clearly differs from the spectrum analysis result of the read signal corresponding to the heater power that is not perturbed by the alternating current. As such, the function generator 210 repeats the processes of S15 to S19, until the difference of the spectrum analysis results is clearly determined.

As described above, according to the first embodiment, the touch-down (TDP) can be detected with high precision.

According to the first embodiment, the frequency of the spectrum of the read signal considered to detect the touch-down (TDP) (spectrum of the read signal corresponding to the alternating current) can be arbitrarily selected by the detection condition optimizing process (refer to FIG. 11). Accordingly, when the frequency of the spectrum of the read signal is selected, the spectrum can be prevented from being affected by noise or other factor. Therefore, detection precision of the touch-down can be improved.

According to the first embodiment, the amplitude (change) and the waveform of the alternating-current superimposed on the heater power can be arbitrarily selected by the detection condition optimizing process (refer to FIG. 11). Accordingly, the waveform corresponding to the protrusion amount of the magnetic head 120 changed due to plasticity of the magnetic head 120 by the heater and by cooling of the magnetic head 120 by the rotation of the magnetic medium 110 can be adjusted, such that the spectrum of the read signal becomes clear. As a result, the touch-down detection precision can be improved.

As in the conventional technology, when the touch-down is detected based on the strength of the read signal recorded on the medium, the touch-down detection precision is lowered as the magnetic head 120 is off-tracked from the record track on the magnetic medium 110 during the detection of the touch-down.

Meanwhile, in the first embodiment, the heater power that increases the protrusion amount of the write magnetic pole and the read element of the head is perturbed by the alternating current, and the touch-down (TDP) is detected while taking into account the change in the spectrum of the read signal corresponding to the alternating current. As a result, according to the first embodiment, regardless of whether the signal is recorded on the magnetic medium 110, and even when the read signal corresponding to the magnetic noise with no magnetic signal recorded is used, the touch-down can be detected.

Therefore, according to the first embodiment, the detection precision of the touch-down can be prevented from being lowered due to the off-track. Even in a system where positioning precision of the magnetic head 120 and the magnetic medium 110 is low, the detection precision of the touch-down can be suppressed from being lowered.

Hereinafter, another embodiment of the touch-down determining device, the touch-down determining method, and the magnetic disk device will be described.

The components according to the first embodiment that are illustrated in FIG. 1 are functional and conceptual, and do not need to have exactly the same physical configuration as that illustrated in FIG. 1. That is, the specific forms of integration and separation of the magnetic disk device 100 and the touch-down determining device 200 are not limited to the forms illustrated in FIG. 1. The functions of the touch-down determining device 200 may be incorporated in the magnetic disk device.

For example, the function of the function generator 210 of the touch-down determining device 200 may be incorporated in the heater driver of the head IC 130 of the magnetic disk device 100. The functions of the spectrum analyzer 220 and the touch-down detector 230 of the touch-down determining device 200 may be incorporated in the read channel 140 of the magnetic disk device 100. As such, all or part of the functions of the touch-down determining device 200 may be mechanically or physically separated or integrated in an arbitrary module according to the various loads or use situations. All or part of the processing functions (refer to FIGS. 10 and 11) that are executed by the touch-down determining device 200 may be executed by firmware analyzed and executed by the MPU or the MCU, or realized as hardware by wired logic.

By the first embodiment described above, the following touch-down determining method is realized. That is, the touch-down determining method comprises: periodically perturbing power of a heater by an alternating current, the heater adjusting protrusion amounts of a write magnetic pole and a read element of a magnetic head in a direction towards a recording medium; detecting a change in a spectrum level of a portion of a spectrum of a read signal read from the recording medium by the magnetic head receiving the power perturbed by the alternating current, the portion of the spectrum corresponding to the alternating current; and determining whether touch-down is made, based on the change in the spectrum level detected by the detecting.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A touch-down determining device, comprising:
an alternating current varying module configured to periodically vary power of a heater by an alternating current, the heater configured to adjust protrusion amounts of a write magnetic pole and a read element of a magnetic head in a direction towards a recording medium;
a fluctuation detector configured to detect a fluctuation in a spectrum level of a portion of a spectrum of a read signal from the recording medium by the magnetic head configured to receive the power varied by the alternating current, the portion of the spectrum corresponding to the alternating current; and
a touch-down determining module configured to determine whether touch-down is made, based on the fluctuation in the detected spectrum level.

2. The touch-down determining device of claim 1, wherein the alternating current varying module is configured to select a shape, an amplitude, and a frequency of a waveform corresponding to the alternating current in order to give a substantial change in the spectrum of the alternating current.

3. The touch-down determining device of claim 1, wherein the touch-down determining module is configured to determine that the touch-down is made, when the spectrum level detected by the fluctuation detector is decreased.

4. A touch-down determining method, comprising:
periodically varying power of a heater by an alternating current, the heater configured to adjust protrusion amounts of a write magnetic pole and a read element of a magnetic head in a direction towards a recording medium;
detecting a fluctuation in a spectrum level of a portion of a spectrum of a read signal from the recording medium by the magnetic head configured to receive the power varied by the alternating current, the portion of the spectrum corresponding to the alternating current; and
determining whether touch-down is made, based on the fluctuation in the detected spectrum level.

5. A magnetic disk device, comprising:
an alternating current varying module configured to periodically vary power of a heater by an alternating current, the heater configured to adjust protrusion amounts of a write magnetic pole and a read element of a magnetic head in a direction towards a recording medium;
a fluctuation detector configured to detect a fluctuation in a spectrum level of a portion of a spectrum of a read signal from the recording medium by the magnetic head configured to receive the power varied by the alternating current, the portion of the spectrum corresponding to the alternating current; and
a touch-down determining module configured to determine whether touch-down is made, based on the fluctuation in the detected spectrum level.

6. The magnetic disk device of claim 5, wherein the alternating current varying module is configured to select a shape, an amplitude, and a frequency of a waveform corresponding to the alternating current in order to give a substantial change in the spectrum of the alternating current.

7. The magnetic disk device of claim 5, wherein the touch-down determining module is configured to determine that the touch-down is made, when the spectrum level detected by the fluctuation detector is decreased.
